(19) United States
(12) Patent Application Publication
(10) Pub. No.: US 2010/0083106 A1
(43) Pub. Date: Apr. 1, 2010

(54) INFORMATION PROCESSING APPARATUS, MESSAGE DISPLAY SYSTEM, MESSAGE DISPLAY METHOD, AND RECORDING MEDIUM

(75) Inventor: Noriaki Kitada, Tokorozawa (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/488,239

(22) Filed: Jun. 19, 2009

(30) Foreign Application Priority Data
Sep. 30, 2008 (JP) 2008-254344

(51) Int. Cl. G06F 17/21; G06F 17/00

(52) U.S. Cl. 715/273; 715/255

(57) ABSTRACT

According to one embodiment, a computer is an information processing apparatus which is connectable to a server apparatus via a network. The computer includes an HDD which stores the model information of the information processing apparatus, a network controller which transmits the model information stored in the HDD to the server apparatus via the network, a CPU which determines, upon receiving, from the server apparatus, support information corresponding to the model information transmitted by the network controller, whether the computer includes a device corresponding to device information contained in the support information, and an LCD which displays, when the CPU determines that the computer includes a device corresponding to the device information, device information corresponding to the device.

### CROSS-REFERENCE TO RELATED APPLICATIONS

This application is based upon and claims the benefit of priority from Japanese Patent Application No. 2008-254344, filed Sep. 30, 2008, the entire contents of which are incorporated herein by reference.

### BACKGROUND

1. Field

One embodiment of the present invention relates to an information processing apparatus, a message display system, a message display method, and a recording medium which make it possible to check the presence/absence of device support information, and display the information, by transmitting minimal data.

2. Description of the Related Art

In general, if support information about, e.g., a malfunction in a device including a computer used by the user is available, the user accesses the web site of a manufacturer or the like. The user then checks support information for each model, and downloads software and the like as needed. For example, Jpn. Pat. Appln. KOKAI Publication No. 2004-234644 discloses a technique in which a server receives movement log information and display condition information from a terminal owned by the user, filters the received information, and transmits necessary information to the terminal owned by the user.

In the technique described in Jpn. Pat. Appln. KOKAI Publication No. 2004-234644, however, even though the terminal owned by the user transmits the movement log information and display condition information to the server and the server then filters the information, the amount of data transmitted by the terminal owned by the user to the server is huge. Furthermore, it takes time for the terminal owned by the user to transmit data to the server.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the configuration of a message display system to which an information processing apparatus according to an embodiment of the present invention is applied;

FIG. 2 is an exemplary block diagram showing the main components of a computer according to the information processing apparatus of the embodiment;

FIG. 3 is an exemplary block diagram showing the functional components of a client application of the computer according to the embodiment;

FIG. 4 is an exemplary block diagram showing the main components of a server apparatus according to the message display system of the embodiment;

FIG. 5 is an exemplary block diagram showing the functional components of the server application of the server apparatus according to the embodiment;

FIG. 6 is an exemplary sequence chart showing a message display method and program to which the message display system and information processing apparatus according to the embodiment are applied;

FIG. 7 is an exemplary table schematically showing support information used in the message display system according to the embodiment; and

FIG. 8 is an exemplary table schematically showing the support information and flag information associated with the message of the support information used in the computer according to the embodiment.

### DETAILED DESCRIPTION

Various embodiments according to the invention will be described hereinafter with reference to the accompanying drawings. In general, according to one embodiment of the invention, an information processing apparatus connectable to a server apparatus via a network, includes: a storage module configured to store model information of the information processing apparatus; a transmission module configured to transmit the model information stored in the storage module to the server apparatus via the network; a determination module configured to determine, upon receiving, from the server apparatus, support information corresponding to the model information transmitted by the transmission module, whether the information processing apparatus includes a device corresponding to device information contained in the support information; and a display unit configured to display, when the determination module determines that the information processing apparatus includes a device corresponding to the device information, device information corresponding to the device.

An embodiment of the present invention will be described below with reference to the accompanying drawings.

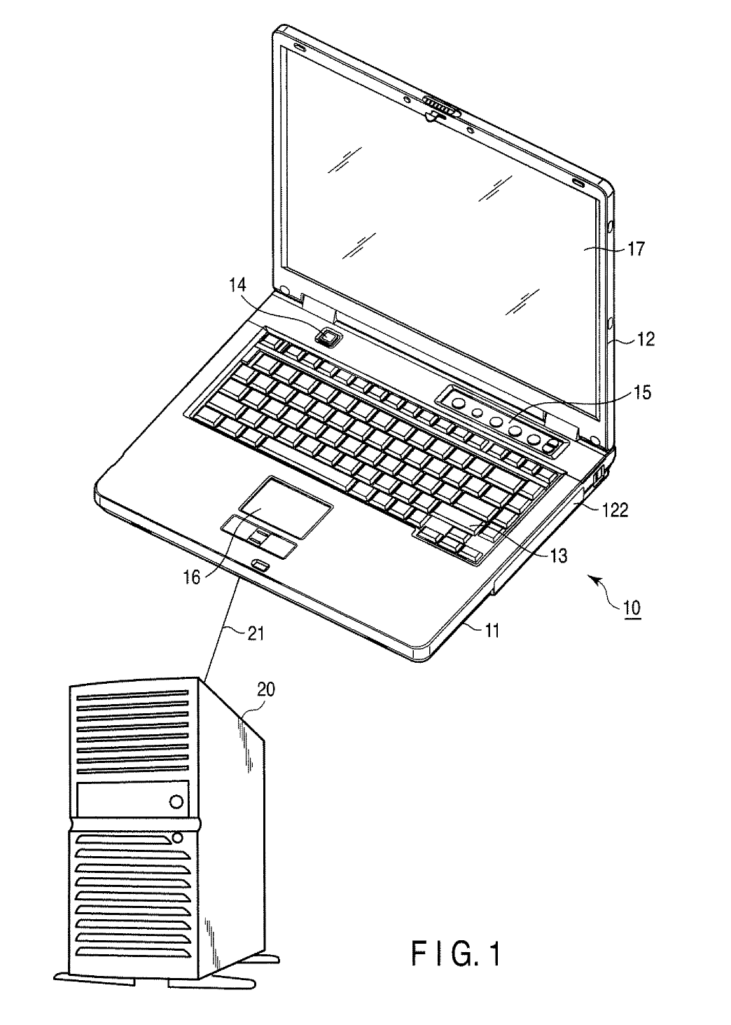

First, the configuration of a message display system to which an information processing apparatus according to the embodiment of the present invention is applied will be explained with reference to FIG. 1. The term “message display” herein indicates that if a personal computer receives hard disk drive support information from a server apparatus, and the received support information corresponds to the hard disk drive serving as a device included in the personal computer, the received support information is displayed as a message on, e.g., a display.

This message display system is implemented as, e.g., a notebook personal computer (client PC) 10 and a server apparatus 20.

FIG. 1 is a perspective view showing a state in which the display unit of the notebook personal computer 10 is open and the server apparatus 20 to which the computer 10 can connect via a network 21. The computer 10 includes a computer main body 11 and display unit 12. The display unit 12 has a built-in display device formed from a liquid crystal display (LCD [display unit]) 17. The display screen of the LCD 17 is located almost at the center of the display unit 12.

The display unit 12 is attached to the computer main body 11 to freely pivot between the open position and the closed position. The computer main body 11 has a thin box-shaped housing and includes, on its upper surface, a keyboard 13, a power button 14 to power on/off the computer 10, an input operation panel 15, and a touch pad 16. Furthermore, an optical disk drive (ODD) 122 and the like are arranged on the side surface of the computer main body 11.

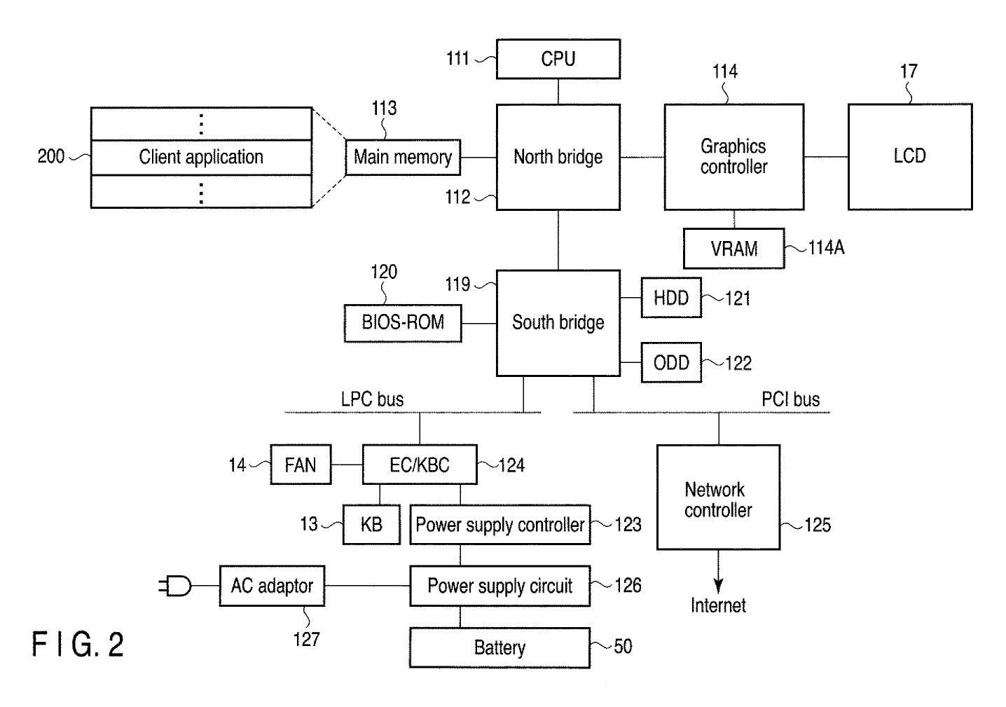

FIG. 2 is a block diagram showing the main components of the computer 10.

The computer 10 includes a CPU (determination module) 111, a north bridge 112, a main memory 113, a graphics controller 114, the display unit (LCD) 17, a south bridge 119, a BIOS-ROM 120, a hard disk drive (HDD: storage module) 121, the optical disk drive (ODD) 122, an embedded controller/keyboard controller IC (EC/KBC) 124, the FAN 14, a power supply controller 123, a power supply circuit 126, a battery 50, an AC adaptor 127, and a network controller (transmission module) 125 for connecting to the network 21 such as the internet.

The CPU 111 is a processor for controlling the operation of the computer 10, and executes an operating system and various application programs such as a client application 200 which are loaded from the hard disk drive (HOD) 121 into the memory 113.

The client application 200 transmits the model information (computer model number) of the computer 10 from the computer 10 serving as a client terminal to the server apparatus 20 at regular intervals. Furthermore, the client application 200 receives, from the server apparatus 20, support information corresponding to the model information of the computer 10 which has been transmitted to the server apparatus 20, and determines (checks) whether the computer 10 includes a device corresponding to the received support information. If the computer 10 includes a device corresponding to the received support information, the client application 200 displays the support information on, e.g., the display (LCD) of the computer 10. It is also possible to set not to display the support information which has been displayed in the past.

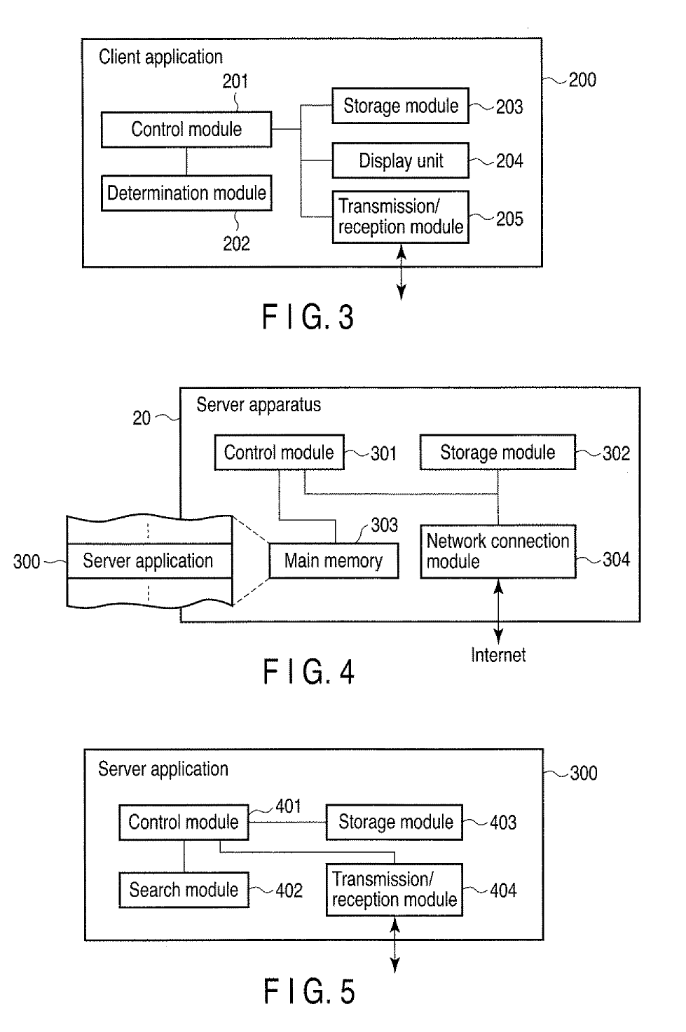

FIG. 3 is a block diagram showing the functional components of the client application 200 of the computer 10 according to the information processing apparatus of the embodiment.

The client application 200 includes a control module 201, determination module 202, storage module 203, display unit 204, and transmission/reception module 205. The control module 201 executes a process of reading the model information of the computer 10 from the storage module 203, a process of transmitting the read model information to the server apparatus 20, and the like. After support information corresponding to the read model information is received from the server apparatus 20, the determination module 202 determines whether the computer 10 includes a device corresponding to the support information. The storage module 203 stores the model information of the computer 10, information on a device included in the computer 10, and the like. The device information contains a device name, serial number, and model number. If the determination module 202 determines that the computer 10 includes a device corresponding to the support information, the display unit 204 displays the support information on the display device such as the LCD 17. The transmission/reception module 205 executes a process of exchanging information with the server apparatus 20 via the network 21.

FIG. 4 is a block diagram showing the components of the server apparatus 20 which is applied to the message display system according to the embodiment.

The server apparatus 20 includes a control module 301, storage module 302, main memory 303, and network connection module 304. The control module 301 executes, e.g., a process of searching for and reading, from the storage module 302, support information corresponding to the model information received from the computer 10. The control module 301 also reads the server application 300 from the storage module 302, toads it into the main memory 303, and executes a process of controlling the server application 300. The storage module 302 stores, e.g., the server application 300 and the support information associated with each model of the computer 10. The control module 301 loads the server application 300 read from the storage module 302 into the main memory 303. The network connection module 304 is an interface device for executing a process of exchanging information with the computer 10 via the network 21.

FIG. 5 is a block diagram showing the functional components of the server application 300 of the server apparatus 20 according to the message display system of the embodiment.

The server application 300 includes a control module 401, search module 402, storage module 403, and transmission/reception module 404. The control module 401 controls the server application 300 as a whole. The search module 402 searches for and reads, from the storage module 403, support information corresponding to the model information received from the computer 10. The storage module 403 stores support information associated with each model of the computer 10, and the like. The transmission/reception module 404 receives model information from the computer 10 via the network 21, and transmits support information corresponding to the model information to the computer 10.

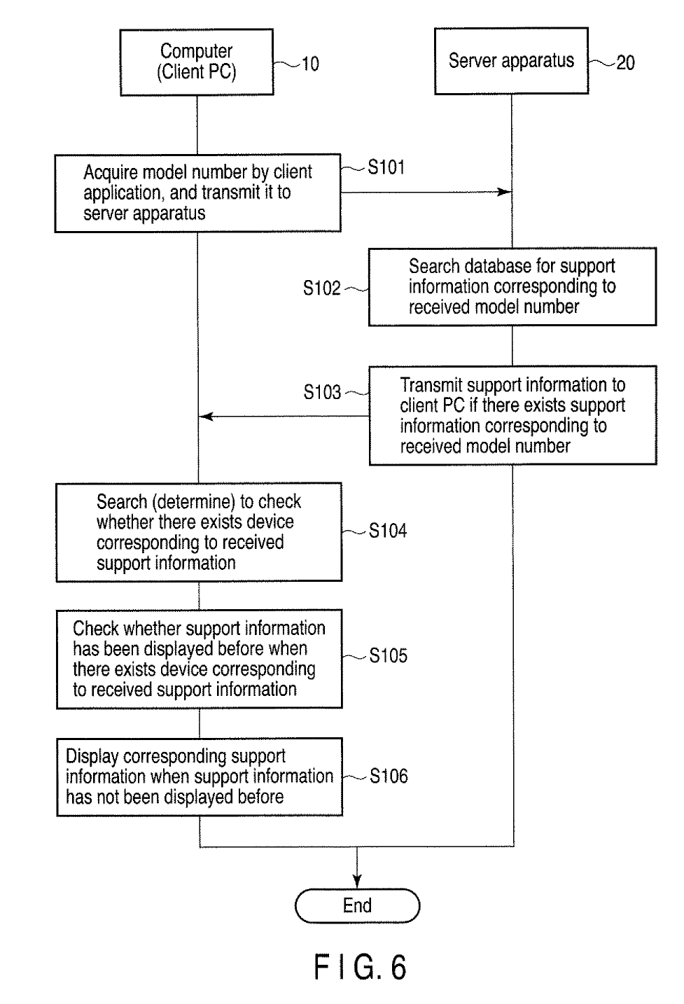

A message display method and program to which the message display system and information processing apparatus with the above-described configuration are applied will be explained with reference to a sequence chart in FIG. 6.

The computer (client PC) 10 uses its client application 200 to acquire (read) the model information (e.g., “001”) of the computer 10 from the HDD 121 at regular intervals, and transmit it to the server apparatus 20 via the network 21 (block S101). Note that the interval between the times of reading the model information of the computer 10 is set to, e.g., once a month.

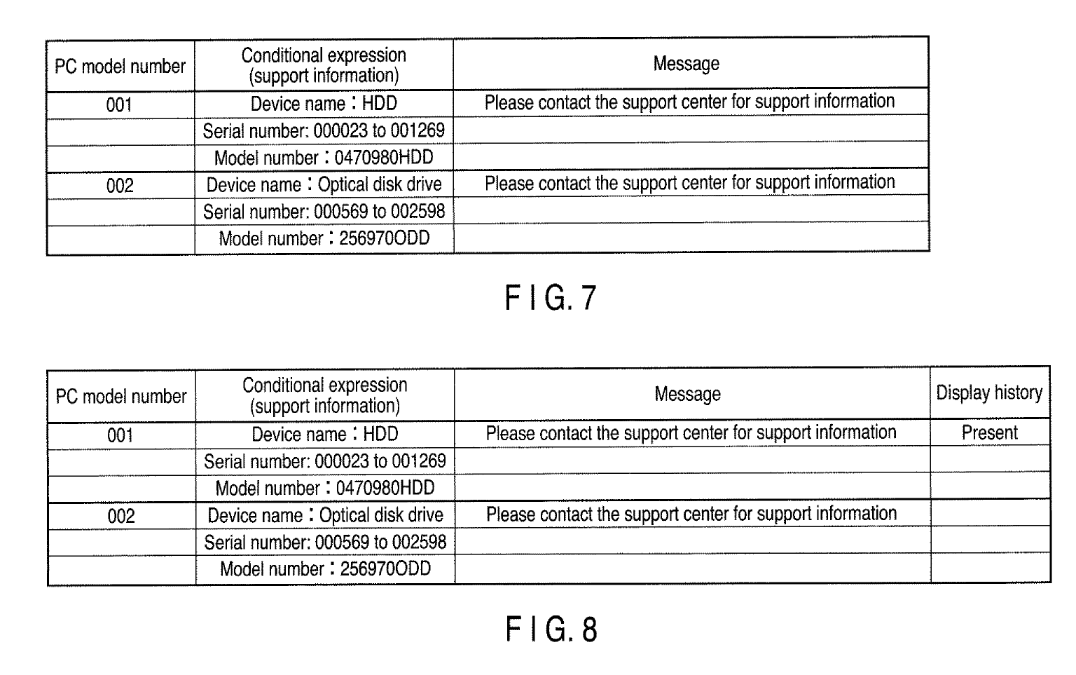

Upon receiving the model information from the computer 10, the server application 300 of the server apparatus 20 searches the database of the storage module 302 of the server apparatus 20 for support information corresponding to the received model information (model name) (block S102). Various conditional expressions and a message are set as the support information in correspondence with the model name (model number) of the computer 10, as shown in, e.g., FIG. 7. As the conditional expressions corresponding to the model number “001”, for example, device name: HDD, serial number: 000023 to 001269, model number: 0470980HDD and message: “Please contact the support center for support information” are set. Similarly, as the conditional expressions corresponding to the model number “002”, device name: optical disk drive, serial number: 000569 to 002598, model number: 2569700DD, and message: “Please contact the support center for support information” are set. Assume that a plurality of items of support information are stored in the database of the server apparatus 20.

If support information corresponding to the received model information (model name) is determined to be stored in the database of the storage module 302 of the server apparatus 20, the server application 300 of the server apparatus 20 transmits the support information corresponding to the computer 10 serving as a client PC (block S103). For example, the server application 300 transmits the conditional expressions and message corresponding to the model number “001”.

The client application 200 of the computer 10 searches (determines) to check whether there exists a device corresponding to the received support information (conditional expressions and message corresponding to the model number “001”) (block S104). That is, the client application 200 searches for a device corresponding to the received support information among the various devices of the computer 10. A case in which the received support information is as follows will be described as an example.

Device name: HDD, serial number: 000023 to 001269, model number: 0470980HDD, and message: “Please contact the support center for support information”

The client application 200 searches for a device corresponding to “device name: HDD” among the various devices of the computer 10. In searching for a device, the client application 200 searches to check whether there exists a corresponding device by using serial number: 000023 to 001269 and model number: 0470980HDD.

If a corresponding device is found among the various devices of the computer 10, the client application 200 determines (checks) whether the message “Please contact the support center for support information” contained in the support information has been displayed before (block S105). This determination is made by referring to flag information indicating a display history associated with the received message (to be described later) (see FIG. 8). If the client application 200 determines in block S105 that the message contained in the received support information has not been displayed before, it displays the message “Please contact the support center for support information” contained in the support information on the display device such as the LCD 17 (block S106). When the message is displayed, the application 200 stores flag information, indicating that the display has been done, in association with the message in the HDD 121 of the computer 10 (see FIG. 8). Although the HDD 121 and the optical disk drive 122 have been used for the support information in the above-described information processing apparatus, the present invention is not limited to them. For example, it is possible to set the support information for various devices such as a battery, memory, built-in keyboard, and touch pad which are the devices of the computer 10, as a matter of course. That is, the server apparatus 20 can store a model information list of the computer 10 serving as a client PC and a plurality of combinations of conditional expressions and messages in association with the model information of the computer 10. A module can be accomplished in software and hardware.

According to the above-described information processing apparatus, by transmitting minimal information from a client terminal to a server, it is possible to display in detail the latest support information of the client terminal while reducing communication traffic. The information transmitted from the client terminal to the server apparatus is limited to only model information, thereby significantly decreasing the information amount transmitted from the client terminal to the server apparatus. It is also possible to notify only the user of the client PC, who needs the support information, of the message.

It is possible to accomplish the procedure of the control processing of the embodiment by software it is therefore possible to readily obtain the same effects as in the embodiment only by installing a program for executing the procedure into a computer through a computer-readable storage medium. The above-described modules can be accomplished as software or hardware.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus connectable to a server apparatus via a network, comprising:
a storage module configured to store model information of the information processing apparatus;
a transmission module configured to transmit the model information stored in the storage module to the server apparatus via the network;
a determination module configured to determine, upon receiving, from the server apparatus, support information corresponding to the model information transmitted by the transmission module, whether the information processing apparatus includes a device corresponding to device information contained in the support information; and
a display unit configured to display, when the determination module determines that the information processing apparatus includes a device corresponding to the device information, device information corresponding to the device.

2. The apparatus of claim 1, wherein display history information of the device information corresponding to the device which is displayed on the display unit is stored in the storage module, and on the basis of the display history information, device information, which has not been displayed, among the device information corresponding to the device is displayed.

3. A message display system comprising a server apparatus and an information processing apparatus which is connectable to the server apparatus via a network,
the server apparatus including
a model information storage module configured to store support information for each item of model information of the information processing apparatus, and
a support information transmission module configured to transmit, upon receiving model information from the information processing apparatus, support information corresponding to the received model information to the information processing apparatus, and
the information processing apparatus including
a storage module configured to store model information of the information processing apparatus,
a transmission module configured to transmit the model information stored in the storage module to the server apparatus via the network,
a determination module configured to determine, upon receiving, from the server apparatus, support information corresponding to the model information transmitted by the transmission module, whether the information processing apparatus includes a device corresponding to device information contained in the support information, and
a display unit configured to display, when the determination module determines that the information processing apparatus includes a device corresponding to the device information, device information corresponding to the device.

4. The system of claim 3, wherein display history information of the device information corresponding to the device which is displayed on the display unit is stored in the storage module, and on the basis of the display history information, device information, which has not been displayed, among the device information corresponding to the device is displayed.

5. A message display method used in a message display system which includes a server apparatus and an information processing apparatus connectable to the server apparatus via a network, comprising:
causing the server apparatus to store support information for each item of model information of the information processing apparatus in a model information storage module of the server apparatus;
when the server apparatus receives model information stored in a storage module of the information processing apparatus from the information processing apparatus via the network, causing the server apparatus to read support information corresponding to the received model information from the model information storage module, and to transmit the support information to the information processing apparatus; and
when the information processing apparatus receives support information corresponding to the transmitted model information, and the information processing apparatus determines that the information processing apparatus includes a device corresponding to device information contained in the support information, displaying device information corresponding to the device on a display unit of the information processing apparatus.

6. The method of claim 5, wherein display history information of the device information corresponding to the device which is displayed on the display unit is stored in the storage module, and on the basis of the display history information, device information, which has not been displayed, among the device information corresponding to the device is displayed.

7. A computer-readable recording medium storing a program which is used in a message display system including a server apparatus and an information processing apparatus connectable to the server apparatus via a network, the program causing a computer to execute
a storage procedure for causing the server apparatus to store support information for each item of model information of the information processing apparatus in a model information storage module of the server apparatus,
a reception procedure for causing the server apparatus to receive model information stored in a storage module of the information processing apparatus from the information processing apparatus via the network,
a transmission procedure for causing the server apparatus to read support information corresponding to the received model information from the model information storage module, and to transmit the support information to the information processing apparatus, and
a display procedure for displaying, when the information processing apparatus receives the support information corresponding to the model information which has been transmitted by the server apparatus, and the information processing apparatus determines that the information processing apparatus includes a device corresponding to device information contained in the support information, device information corresponding to the device on a display unit of the information processing apparatus.

8. The medium of claim 7, wherein display history information of the device information corresponding to the device which is displayed on the display unit is stored in the storage module, and on the basis of the display history information, device information, which has not been displayed, among the device information corresponding to the device is displayed.
